(19) United States
(12) Patent Application Publication
(10) Pub. No.: US 2018/0273078 A1
(43) Pub. Date: Sep. 27, 2018

(54) STEERING DEVICE AND METHOD FOR PRODUCING THE SAME

(71) Applicant: NIHON PLAST CO., LTD., Shizuoka (JP)

(72) Inventors: Takashi MITOBE, Shizuoka (JP); Akihiko YAMAMI, Guangdong (CN); Nobutaka UEMATSU, Shizuoka (JP); Yuta INABA, Shizuoka (JP)

(21) Appl. No.: 15/933,445

(22) Filed: Mar. 23, 2018

(30) Foreign Application Priority Data
Mar. 23, 2017 (JP) 2017-057344

(51) Int. Cl. B62D 1/06; H05B 3/40

(52) U.S. Cl. CPC B62D 1/065; H05B 2203/017; H05B 3/40

(57) ABSTRACT

A spacer is interposed between a rim core metal and an electronic part, so that the electronic part can be easily disposed. An opening is formed in the spacer such that the opening is positioned to face an overflow portion that is formed in a mold for molding of a resin layer and that is provided for a fluid synthetic resin raw material to overflow. Even when air bubbles are generated in the synthetic resin raw material between the spacer and a core metal, the synthetic resin raw material overflowing to the overflow portion can easily eject the air bubbles to the overflow portion via the opening and the air bubbles can be prevented from remaining in the resin layer.

### CROSS REFERENCE TO RELATED APPLICATIONS

This application is entitled to and claims the benefit of Japanese Patent Application No. 2017-057344, filed on Mar. 23, 2017, the disclosure of which including the specification, drawings and abstract is incorporated herein by reference in its entirety.

### TECHNICAL FIELD

The present invention relates to a steering device provided with an electronic part and to a method for producing the steering device.

### BACKGROUND ART

In recent years, electric vehicles (EVs), which involve less environmental burdens, have become popular and been adopted as replacements for gasoline-engine vehicles for an approach to conserve the global environment and to reduce the production of greenhouse gases. Such an electric vehicle includes a combination of a storage battery and a motor and basically needs to charge power from an external charger. For this reason, measures to reduce the consumption of battery power are required for the electric vehicles. In this respect, reducing the power consumption of a heater (air conditioner), which requires a large amount of power consumption among onboard devices, is the most effective solution.

To this end, a technique to directly conduct heat to a passenger (driver) via a steering wheel to be directly held by the passenger has been adopted. As an example of the technique, a configuration in which a heating wire serving as a heating element is embedded in the steering wheel is known.

In this configuration, a heating device is incorporated into a steering wheel and the steering wheel is heated during a period even a little after the engine starts, i.e., even when each engine part is not yet heated enough. This configuration can reduce the opportunity to use a heater and thus can reduce the power consumption while mitigating operational difficulty and/or discomfort caused by the cold steering, for example, when a driver starts an automobile that has been parked outside in winter.

Techniques of producing the aforementioned configuration include the following technique: a cylindrical spacer for covering a rim core-metal portion of a core metal is provided; a heating wire is held externally to the spacer by hooks in a zigzag course, for example; the rim core-metal portion covered with the spacer to which the heating wire is held is set in a mold cavity; and a resin layer is then molded by causing a synthetic resin raw material, such as urethane, to react within the mold cavity, and thus the rim portion of the steering wheel in which the heating wire is embedded is formed (for example, see Patent Literature (hereinafter referred to as “PTL”) 1).

### CITATION LIST

### Patent Literature

PTL 1
Japanese Patent Application Laid-Open No. 2013-139203 (pages 4 to 6, FIGS. 1 to 5)

### SUMMARY OF INVENTION

### Technical Problem

When the spacer as described above is used, air bubbles (voids) may be generated in the synthetic resin raw material between the spacer and the core metal. Accordingly, there is a demand for a configuration that allows the air bubbles to escape easily so that the resin layer should not be molded while the air bubbles remain in the resin layer.

The present invention takes the above mentioned points into consideration and aims to provide a steering device and a method for producing the steering device in which disposing an electronic part can be made easier and the air bubbles can be prevented from remaining in the resin layer.

### Solution to Problem

A steering device according to a first aspect is a steering device including a grip portion to be gripped for operation and includes: a core including a grip-portion core corresponding to the grip portion; an electronic part; a spacer to be interposed between the grip-portion core and the electronic part; and a resin layer to be formed to integrally cover at least the grip-portion core, the electronic part, and the spacer. In the steering device, the spacer includes therein an opening at a position where the opening faces an overflow portion of a mold for molding of the resin layer, the overflow portion of the mold being adapted to cause a fluid resin raw material for the resin layer to partly overflow.

A steering device according to a second aspect is the steering device according to the first aspect, in which the spacer further includes therein a communicating hole passing through from an inside to an outside of the spacer, the inside of the spacer being a side of the grip-portion core, the outside of the spacer being a side opposite to the inside.

A steering device according to a third aspect is the steering device according to the first aspect, in which the electronic part is sheetlike and includes therein a pore, the electronic part being wrapped externally around the spacer such that the pore is positioned to face at least the opening.

A steering device according to a fourth aspect is the steering device according to the first aspect, in which the grip portion is formed in a shape of a circular arc, and the opening is formed in a slit shape along a circumferential direction of the grip portion.

A method for producing a steering device according to a fifth aspect is a method for producing a steering device including a grip portion to be gripped for operation, a core including a grip-portion core corresponding to the grip portion, an electronic part, a spacer including an opening, and a resin layer, and the method includes: preparing a mold including a cavity, a gate, and an overflow portion, the gate and the overflow portion each being in communication with the cavity; setting an intermediate body in the cavity of the mold, the intermediate body including the grip-portion core, the spacer, and the electronic part, the grip-portion core being covered with the spacer, the electronic part being disposed externally to the spacer, and the intermediate body being set such that the opening is positioned to face the overflow portion; and forming the resin layer by filling the cavity with a fluid resin raw material through the gate and by causing the fluid resin raw material to partly overflow from the overflow portion, the resin layer integrally covering at least the grip-portion core, the electronic part, and the spacer.

### Advantageous Effects of Invention

With the steering device according to the first aspect, a spacer is interposed between a grip-portion core and an electronic part, so that the electronic part can be easily disposed; besides, an opening is formed in the spacer such that the opening is positioned to face an overflow portion which is formed in a mold for molding of a resin layer and from which a fluid resin raw material overflows, so that even when air bubbles are generated in the resin raw material between the spacer and the core, part of the resin raw material overflowing toward the overflow portion ejects the air bubbles easily to the overflow portion via the opening so as to prevent the air bubbles from remaining in the resin layer.

With the steering device according to the second aspect, in addition to the effects obtained with the steering device according to the first aspect, a communicating hole is formed in the spacer, so that the fluid resin raw material can be easily caused to flow toward the inside of the spacer and thus the resin layer can be easily molded.

With the steering device according to the third aspect, in addition to the effects obtained with the steering device according to the first aspect, a sheetlike electronic part including a pore is wrapped externally around the spacer such that the pore is positioned to face at least the opening, so that it is made less possible that the electronic part disturbs the ejection of the air bubbles from the opening to the overflow portion.

With the steering device according to the fourth aspect, in addition to the effects obtained with the steering device according to the first aspect, the opening is formed in a slit shape along the circumferential direction of a grip portion, so that the opening positioned inside the resin layer is made less perceptible to an operator and accordingly the grip portion is pleasant to the touch when the operator grips the grip portion.

With the method for producing a steering device according to the fifth aspect, an intermediate body is formed by covering a grip-portion core with a spacer and by disposing an electronic part externally to the spacer, so that the electronic part can be easily disposed; besides, a resin layer is formed by setting this intermediate body in a cavity of a mold such that an opening is positioned to face an overflow portion, by filling the cavity with a fluid resin raw material through a gate, and by causing part of the resin raw material to overflow from the overflow portion, so that even when air bubbles are generated in the resin raw material between the spacer and the core, the part of the resin raw material overflowing toward the overflow portion ejects the air bubbles easily to the overflow portion via the opening so as to prevent the air bubbles from remaining in the resin layer.

### BRIEF DESCRIPTION OF DRAWINGS

FIG. 1A is an enlarged front view illustrating a part of a steering device according to one embodiment of the present invention during injection process of a method for producing the steering device;

FIG. 1B is a front view illustrating a state during the injection process and following a state illustrated in FIG. 1A;

FIG. 2A is a schematic front view illustrating a opened state of a mold for the steering device;

FIG. 2B is a schematic front view illustrating setting process of the method for producing the steering device;

FIG. 2C is a schematic front view illustrating the injection process of the method for producing the steering device;

FIG. 3A is a schematic front view illustrating a demolding process of the method for producing the steering device;

FIG. 3B is a schematic front view illustrating a finishing process of the method for producing the steering device;

FIG. 4A is a front view illustrating a part of a steering device main body of the steering device;

FIG. 4B illustrates the steering device main body illustrated in FIG. 4A as seen in the direction of arrow X;

FIG. 5A is a sectional view taken along line I-I in FIG. 4A;

FIG. 5B is a perspective sectional view of a rim portion; and

FIG. 6 is a front view illustrating the steering device.

### DESCRIPTION OF EMBODIMENTS

Hereinafter, an embodiment of the present invention will be described with reference to the accompanying drawings.

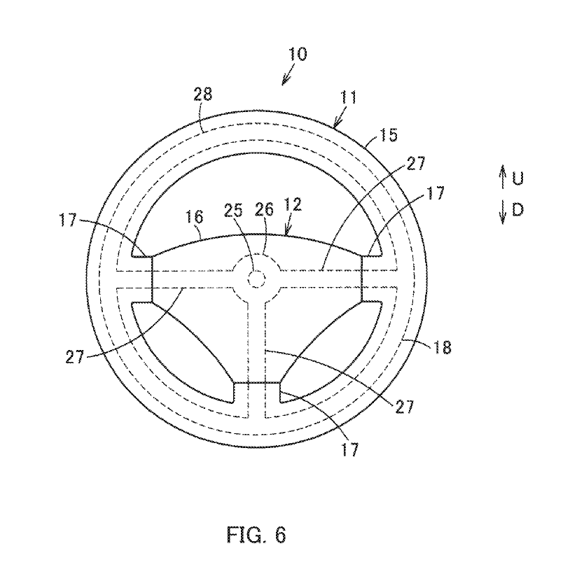

In FIG. 6, reference numeral “10” denotes a steering wheel that is a steering device of an automobile as a vehicle, for example. Steering wheel 10 includes: steering wheel main body 11, which serves as a steering device main body; airbag unit (airbag module) 12, which is a center pad serving as a pad body attached to a passenger side of steering wheel main body 11; and the like. Steering wheel 10 is attached to a steering shaft installed obliquely to a vehicle, normally. However, in the description below, the passenger side (i.e., the front side) of airbag unit 12 is referred to as an upper side (direction indicated by arrow U); the steering shaft side (i.e., the rear side) thereof is referred to as a lower side (direction indicated by arrow D); the windshield side on the front side (the upper front side) of the vehicle is referred to as a front side; and the rear side (i.e., the lower rear side) of the vehicle is referred to as a rear side.

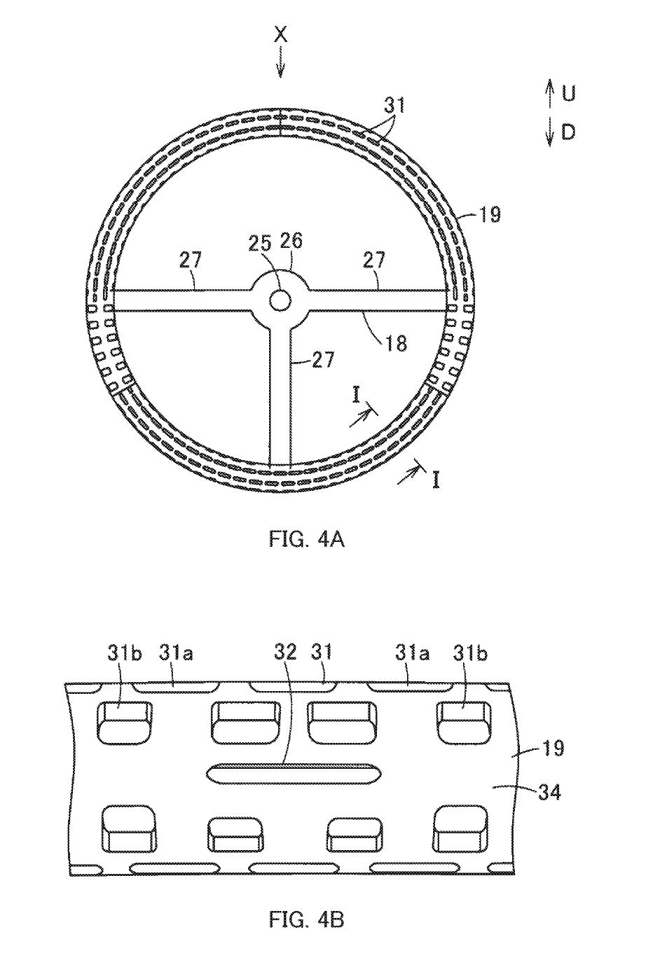

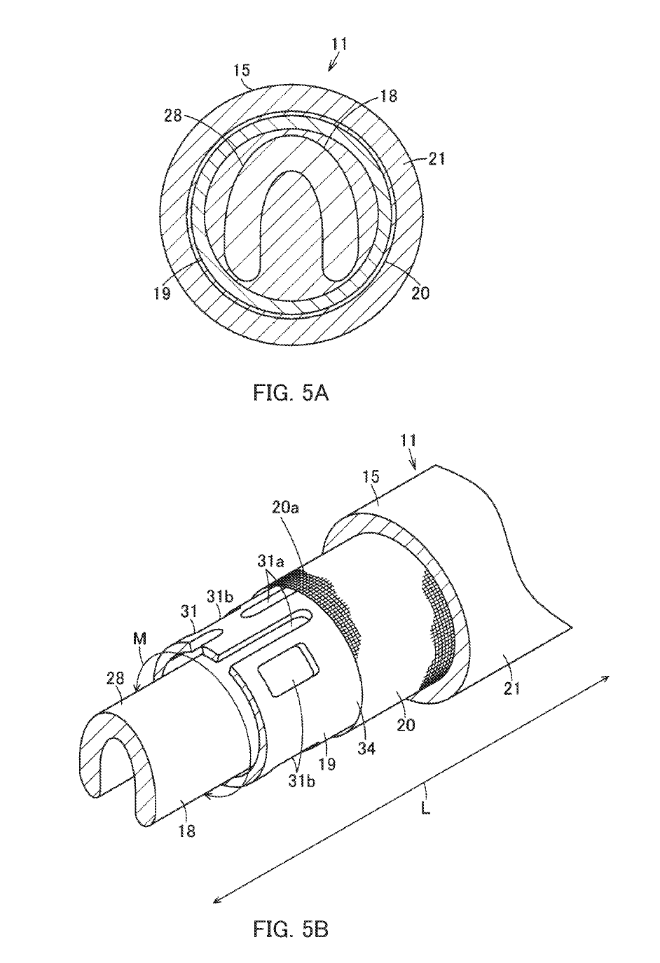

Steering wheel main body 11 includes rim portion 15 serving as a grip portion, boss portion 16, and spoke portions 17. At least part of rim portion 15 is formed circumferentially and, in the embodiment of the present invention, is formed in an annular shape (doughnut shape). Boss portion 16 is positioned inside this rim portion 15. There are a plurality of spoke portions 17 (three spoke portions in the embodiment of the present invention) between rim portion 15 and boss portion 16, and each of spoke portions 17 couples rim portion 15 with boss portion 16. The structure of this steering wheel main body 11 is as illustrated in FIGS. 4A, 4B, 5A, and 5B. That is, steering wheel main body 11 includes core metal 18 made of metal, spacer 19, electronic part 20, resin layer 21, and a covering body (not illustrated) as a covering member. Note that, steering wheel main body 11 may include a skin portion that covers resin layer 21.

Core metal 18 is formed of a magnesium-aluminum (MgAl) alloy or iron, for example. Core metal 18 includes substantially cylindrical boss 25, which includes a serration structure to mesh with the steering shaft, at a lower portion of boss portion 16 that is the vehicle body side of boss portion 16. Boss plate 26, which forms a core body, is integrally and fixedly attached to boss 25. In addition, spoke core bars 27, which correspond to spoke portions 17, extend integrally from boss plate 26. Alternatively, spoke core bars 27 are fixedly attached to boss plate 26 by welding, for example. Moreover, rim core metal 28, which serves as a grip-part core corresponding to rim portion 15, is fixedly attached to spoke core bars 27 of spoke portions 17 by welding, for example.

Spoke core bars 27 extend radially from boss 25. Spoke core bars 27 do not have to correspond to all spoke portions 17; accordingly, some of spoke portions 17 may be composed, for example, of the covering member (finisher) without being provided with spoke core bar 27.

Rim core metal 28 is formed in a circular arc shape (annular shape) in the embodiment of the present invention.

Spacer 19 is also referred to as a shell or the like and serves for disposing electronic part 20 to the periphery of rim core metal 28. That is, spacer 19 is interposed between rim core metal 28 and electronic part 20, as illustrated in FIGS. 5A and 5B. Spacer 19 is formed from a synthetic resin, for example. Spacer 19 is formed in a circular arc shape (annular shape) so as to cover rim core metal 28 over the entire circumference of rim core metal 28. In addition, spacer 19 is formed in the shape of a tube (cylinder). Accordingly, spacer 19 is formed in the shape of a hollow doughnut. Communicating holes 31 are formed in spacer 19. In addition, opening 32 is formed in spacer 19.

Spacer 19 is divided into multiple members, for example, and is then attached to the periphery of rim core metal 28. That is, spacer 19 is attached to the periphery of rim core metal 28 while rim core metal 28 is positioned inside spacer 19. Spacer 19 is disposed to cover rim core metal 28 at a distance from rim core metal 28. That is, a space is defined between spacer 19 and rim core metal 28.

Communicating holes 31 are a portion through which synthetic resin raw material R passes when resin layer 21 described below is molded; in this case, synthetic resin raw material R is a liquid resin raw material as a reaction mixture that becomes polyurethane after reaction. Communicating holes 31 are formed in spacer 19 to penetrate the outer peripheral surfaces of spacer 19, and pass through spacer 19 from the inside of spacer 19 that is the side of rim core metal 28 to the outside thereof that is opposite to the inside of spacer 19 and is the side of electronic part 20. Such communicating holes 31 are multiple in number. For example, multiple communicating holes 31 are formed in spacer 19 along the circumferential direction of spacer 19. In the embodiment of the present invention, communicating holes 31 include, for example, first communicating holes 31a that are an oblong hole and second communicating holes 31b that are a square hole. First communicating holes 31a are formed in spacer 19 into the shape of an oblong hole along the circumferential direction of rim portion 15. Multiple rows of first communicating holes 31a are disposed in spacer 19 along latitude line L (the circumferential direction) of spacer 19 (rim portion 15). These rows are positioned side by side along meridian line M (the circumferential direction of a section of spacer 19). In this respect, first communicating holes 31a in the rows adjacent to each other along meridian line M are disposed to be offset from each other in the circumferential direction (the direction of latitude line L). In addition, second communicating holes 31b are disposed to be offset from first communicating holes 31a in the direction of meridian line M. In this respect, first communicating holes 31a and second communicating holes 31b are disposed entirely in spacer 19 at substantially regular intervals in the circumferential direction (the direction of latitude line L) of spacer 19 (rim portion 15), respectively.

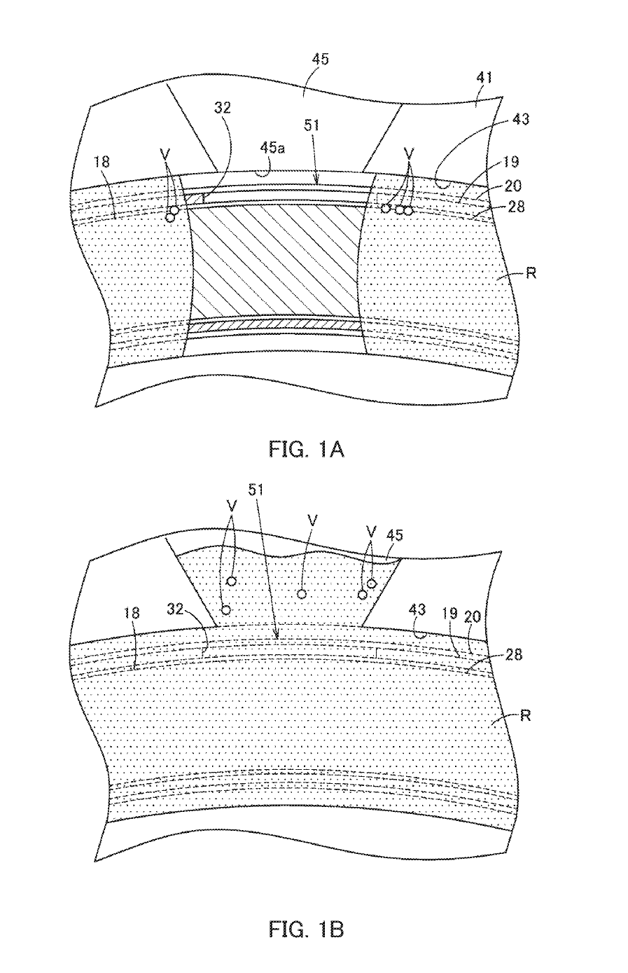

Opening 32 is for ejecting air bubbles (voids) V (FIGS. 1A and 1B) contained in synthetic resin raw material R during a process of molding of resin layer 21 as described below. For example, as illustrated in FIG. 4A, opening 32 is formed in the upper portion of rim portion 15 (spacer 19) in front view, that is, formed at the position of the numeral “12” on an analog clock in the embodiment of the present invention. In other words, opening 32 is formed in the top portion (topmost portion) of rim portion 15 in the present embodiment. In addition, opening 32 is formed along the longest latitude line (a portion at a position of the maximum diameter) of spacer 19. Accordingly, a portion of spacer 19 along the longest latitude line (the portion at the position of the maximum diameter of spacer 19) is unopened portion 34 having no opening except for opening 32 and being closed. Moreover, opening 32 is formed in the shape of a longitudinal slit along the circumferential direction of rim portion 15, that is, along the longitudinal direction, (extending direction).

Electronic part 20 is for adjusting the temperature of rim portion 15, for example. To be more specific, although a sheet member provided with electrical heating wires, an electrical heater wire, or a sensor member configured to detect the temperature of rim portion 15 is used as electronic part 20, a sensor (a pressure sensor, capacitive sensor, or the like) for checking that the passenger is gripping rim portion 15 may be used as electronic part 20. Electronic part 20 is formed into a sheet and is a porous member, for example. For example, a non-woven fabric, mesh, or the like can be used as the aforementioned sheet member. Thus, multiple pores 20a are formed in electronic part 20. Electronic part 20 is connected to a control circuit (not illustrated) and is configured to detect the temperature of rim portion 15 by being energized by this control circuit and configured to generate heat depending on the detected temperature. In addition, electronic part 20 is disposed to be wrapped externally around spacer 19 (i.e., around the outer peripheral surface of spacer 19), for example, and to entirely cover spacer 19. Thus, electronic part 20 is wrapped externally around spacer 19 such that pores 20a is positioned to correspond at least to (face at least) opening 32.

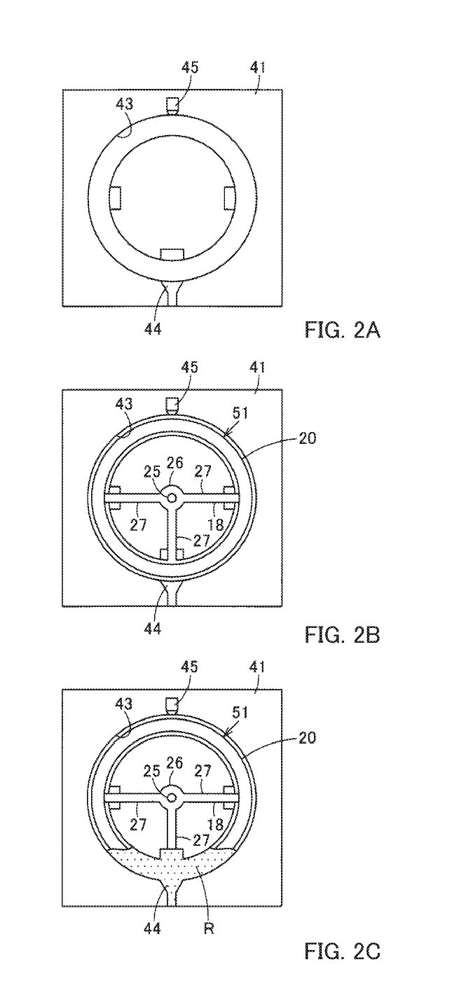

Resin layer 21 is provided to cover rim core-metal 28 entirely and to cover spoke core bars 27 partially. Accordingly, resin layer 21 is formed in a substantially circular shape in cross-sectional view and is formed in an annular shape (a circular arc shape) in front view. To be more specific, resin layer 21 is provided to cover, at a position of rim portion 15, rim core metal 28, spacer 19, and electronic part 20 integrally and to cover, at a position of spoke portion 17, the ends of spoke core bars 27 on the side where spoke core bars 27 and rim core metal 28 are continuous with each other. That is, the space between rim core metal 28 and spacer 19 and the space between spacer 19 and electronic part 20 are both filled with resin layer 21. In other words, rim core metal 28, spacer 19, and electronic part 20 are embedded in resin layer 21. In the embodiment of the present invention, a microcellular foamed soft polyurethane resin is used for resin layer 21, for example. Resin layer 21 is molded using mold (metal mold) 41 illustrated in FIG. 2A or the like.

In this embodiment, in brief, mold 41 includes the first and the second half molds, and cavity 43, gate 44, overflow portion 45, and the like are formed between the first and the second half molds. In the embodiment of the present invention, during the use of mold 41, gate 44 is positioned at the lower portion (the position of the numeral “6” on an analog clock as seen from the front) and overflow portion 45 is positioned at the upper portion (the position of the numeral “12” on an analog clock as seen from the front) of mold 41. Thus, resin layer 21 is molded while positioned in substantially the same as a position of steering wheel 10 during use (FIG. 6).

Cavity 43 is a (first) space having a shape corresponding to the shape of rim portion 15 (resin layer 21), in which case the space has a circular sectional shape and is annular in front view, for example. Cavity 43 is filled with synthetic resin raw material R injected through gate 44.

Gate 44 is a portion through which synthetic resin raw material R is injected into cavity 43. Gate 44 is also called e.g., a fan gate, is in communication with cavity 43, and is formed to gradually expand toward cavity 43. A mixer part (not illustrated) for stirring, mixing, and discharging synthetic resin raw material R is connected to gate 44.

Overflow portion 45 is adapted to eject gas within cavity 43 by causing part of synthetic resin raw materials R injected in cavity 43 to overflow. Overflow portion 45 is in communication with cavity 43 and, for example, is formed to gradually expand in the direction away from cavity 43. Overflow portion 45 is disposed in cavity 43 at a position opposite to the position of gate 44 in front view. That is, overflow portion 45 is positioned at the end of the passage through which synthetic resin raw material R injected through gate 44 into cavity 43 flows. In other words, overflow portion 45 is provided at a position in cavity 43 where synthetic resin raw material R injected into cavity 43 reaches last, that is, at a position corresponding to a weld in molding. In addition, as illustrated in FIGS. 1A and 1B, overflow portion 45 is in communication with cavity 43 via opening 45a having a width equal to that of opening 32 of spacer 19.

The lower portion of boss portion 16 is covered with the cover body (not illustrated). This cover body may also be called, “rear cover,” “lower cover,” or “body cover” and is made of a synthetic resin or the like.

Airbag unit 12 illustrated in FIG. 6 includes: a sack-like airbag; the aforementioned cover body that is made of resin and is adapted to cover a folded airbag; and an inflator configured to inject a gas. Airbag unit 12 is configured to quickly inject a gas to the inside of the airbag from the inflator to rapidly inflate the airbag housed in a folded state to break the cover body during an automobile collision or the like. Thus, the airbag is inflated and deployed in front of a passenger to protect the passenger. Note that, a horn switch mechanism serving as a switch unit may be integrally incorporated into airbag unit 12.

In producing steering wheel 10, first, as illustrated in FIG. 2B, first intermediate body 51 serving as the intermediate body is preformed by covering, with spacer 19, the outer periphery of rim core metal 28 of core metal 18 united in advance with boss plate 26 and the like and by wrapping electronic part 20 around the outer surface of spacer 19. Then, after first intermediate body 51 is set in mold 41 in a state where the first and the second half molds are opened, cavity 43 is formed by mold-joining (mold-closing) of the first and the second half molds (setting process). In this state, rim core metal 28 and parts of spoke core bars 27 are positioned within cavity 43, and opening 32 in spacer 19 is positioned to correspond to (face) overflow portion 45 of mold 41 (see FIG. 1A). That is, intermediate body 51 is set in cavity 43 of mold 41 such that opening 32 of spacer 19 is positioned to correspond to (face) overflow portion 45.

Subsequently, as illustrated in FIG. 2C, synthetic resin raw material R is stirred and mixed at the mixer part, and is injected through gate 44 of mold 41 into cavity 43 (injection process). At this time, the flow of synthetic resin raw material R through gate 44 is substantially equally split within cavity 43 into flows on both right and left sides in the drawing of FIG. 2C. Pores 20a in electronic part 20 are impregnated with synthetic resin raw material R, and synthetic resin raw material R further passes through communicating holes 31 (first communicating holes 31a and second communicating holes 31b) in spacer 19 to enter from the outside to the inside of spacer 19. In this case, synthetic resin raw material R flows toward overflow portion 45 where the flow ends, while being reacted and foamed to become polyurethane.

Then, in the vicinity of overflow portion 45, the flows of synthetic resin raw material R split on the right and left sides within cavity 43 join and part of synthetic resin raw material R flows out of cavity 43 through opening 45a into overflow portion 45 while expanding, as illustrated in FIGS. 1A and 1B. At this time, synthetic resin raw material R, when flowing through the space between rim core metal 28 and spacer 19 on the inside of spacer 19, pushes out air bubbles V positioned in this space through opening 32 to overflow portion 45. Consequently, cavity 43 is filled with synthetic resin raw material R, without air bubbles V remaining in cavity 43.

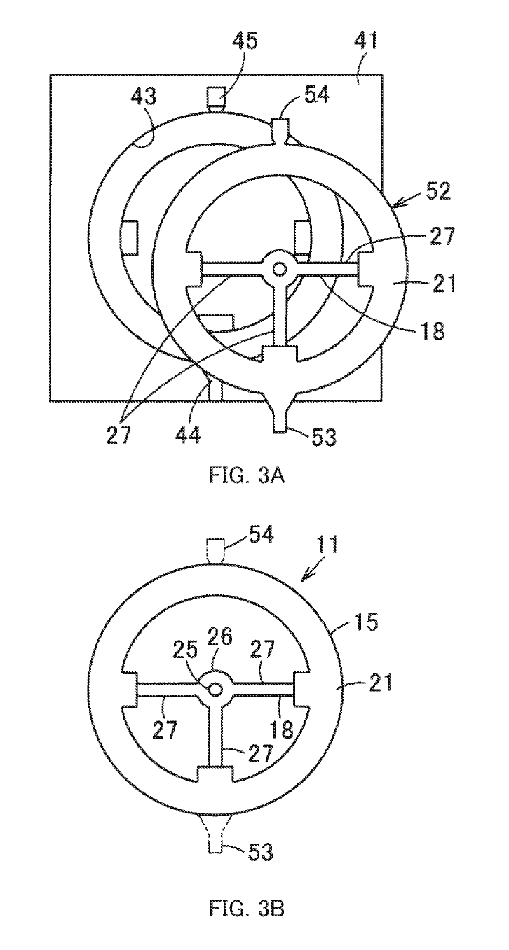

Then, the first and the second half molds are opened, and second intermediate body 52 formed by integrally covering rim core metal 28, spacer 19, and electronic part 20 with resin layer 21 within cavity 43 as illustrated in FIG. 3A is demolded from mold 41 (demolding process). Then, as illustrated in FIG. 3B, burr 53 formed from synthetic resin raw material R remaining at the position of gate 44 of mold 41 and burr 54 formed from synthetic resin raw material R projecting at the position of overflow portion 45 (FIG. 2A) are removed, e.g., by being cut from second intermediate body 52 (finishing process). In this way, steering wheel main body 11 is produced. Electronic part 20 illustrated in FIG. 1A or the like is electrically connected to the control circuit in steering wheel main body 11 and, in addition, airbag unit 12 and the like are attached to steering wheel main body 11 as illustrated in FIG. 6. In this way, steering wheel 10 is produced. That is, steering wheel 10 can be formed in the embodiment of the present invention without a skin body being wrapped around the surface of rim portion 15 and without need to perform multiple molding processes.

As described above, according to the embodiment, spacer 19 is interposed between rim core metal 28 and electronic part 20. That is, first intermediate body 51 is formed by covering rim core metal 28 with spacer 19 and by disposing electronic part 20 externally to spacer 19. With this construction, electronic part 20 is easily disposed around rim core metal 28; moreover, opening 32 is formed in spacer 19 to be positioned to correspond to (face) overflow portion 45 that is formed in mold 41 for molding of resin layer 21 and that is provided for fluid synthetic resin raw material R to overflow. In other words, resin layer 21 is formed by setting first intermediate body 51 in cavity 43 of mold 41 such that opening 32 is positioned to correspond to (face) overflow portion 45, filling cavity 43 with fluid synthetic resin raw material R through gate 44, causing part of synthetic resin raw material R to overflow from overflow portion 45, so that, even when air bubbles V are generated in synthetic resin raw material R between spacer 19 and core metal 18 (rim core metal 28), synthetic resin raw material R overflowing to overflow portion 45 can easily eject air bubbles V to overflow portion 45 via opening 32 and the air bubbles can be prevented from remaining in resin layer 21. Therefore, a hole, recess, or the like to be formed in resin layer 21 due to air bubbles V having remained in resin layer 21 can be prevented, and thus a lower fraction defective can be expected. In addition, cavity 43 of mold 41 can be filled with fluid synthetic resin raw material R smoothly, a molding cycle can be shortened, productivity can be increased, and it is possible to use the present invention for rim portion 15 having a more complicated shape.

Moreover, communicating holes 31 are formed in spacer 19, so that fluid synthetic resin raw material R can flow toward the inside of spacer 19 easily and resin layer 21 can be molded easily.

Further, sheetlike electronic part 20 including pores 20a is wrapped externally around spacer 19 such that pores 20a are positioned to correspond at least to (face at least) opening 32, so that it is made less possible that electronic part 20 disturbs the ejection of air bubbles through opening 32 to overflow portion 45.

Furthermore, sheetlike electronic part 20 is attached to spacer 19 such that communicating holes 31 in spacer 19 are closed, so that spacer 19, electronic part 20, and resin layer 21 can be united more firmly since resin layer 21 comes into tight contact with electronic part 20 from both of the inside and outside of spacer 19 at the positions of communicating holes 31.

In addition, opening 32 is formed in a slit shape along with the circumferential direction of rim portion 15 (that is, opening 32 is long along latitude line L), so that opening 32 positioned inside resin layer 21 is made less perceptible to an operator and accordingly rim portion 15 is pleasant to the touch when the operator grips rim portion 15.

Note that, in the aforementioned embodiment, the position of opening 32 is not limited to the position of the numeral “12” of rim portion 15 regraded as an analog clock, and opening 32 can be positioned at any position other than the position of the numeral 12 as long as opening 32 is positioned to correspond to (face) overflow portion 45.

Moreover, steering wheel 10 is not limited to a steering wheel including three spoke portions 17, and is applicable as a steering wheel including two spoke portions at least on two lateral sides, respectively.

Moreover, steering wheel 10 can be employed as a steering wheel not only for a vehicle such as an automobile, but also for any machine.

Moreover, a pad body that houses a shock absorber, for example, may be used instead of airbag unit 12.

### INDUSTRIAL APPLICABILITY

The present invention is favorably used for a steering wheel of an automobile, such as an electric vehicle, for example.

### REFERENCE SIGNS LIST

10 Steering Wheel serving as Steering Device
15 Rim Portion serving as Grip Portion
18 Core Metal
19 Spacer
20 Electronic Part
20a Pore
21 Resin Layer
28 Rim Core Metal serving as Grip-portion Core
31 Communicating Hole
32 Opening
41 Mold
43 Cavity
44 Gate
45 Overflow Portion
51 First Intermediate Body serving as Intermediate Body
R Synthetic Resin Raw Material serving as Resin Raw Material

1. A steering device including a grip portion to be gripped for operation, the steering device comprising:
a core including a grip-portion core corresponding to the grip portion;
an electronic part;
a spacer to be interposed between the grip-portion core and the electronic part; and
a resin layer to be formed to integrally cover at least the grip-portion core, the electronic part, and the spacer, wherein
the spacer includes therein an opening at a position where the opening faces an overflow portion of a mold for molding of the resin layer, the overflow portion of the mold being adapted to cause a fluid resin raw material for the resin layer to partly overflow.

2. The steering device according to claim 1, wherein
the spacer further includes therein a communicating hole passing through from an inside to an outside of the spacer, the inside of the spacer being a side of the grip-portion core, the outside of the spacer being a side opposite to the inside.

3. The steering device according to claim 1, wherein
the electronic part is sheetlike and includes therein a pore, the electronic part being wrapped externally around the spacer such that the pore is positioned to face at least the opening.

4. The steering device according to claim 1, wherein:
the grip portion is formed in a shape of a circular arc, and
the opening is formed in a slit shape along a circumferential direction of the grip portion.

5. A method for producing a steering device, the steering device including a grip portion to be gripped for operation, a core including a grip-portion core corresponding to the grip portion, an electronic part, a spacer including an opening, and a resin layer, the method comprising:
preparing a mold including a cavity, a gate, and an overflow portion, the gate and the overflow portion each being in communication with the cavity;
setting an intermediate body in the cavity of the mold, the intermediate body including the grip-portion core, the spacer, and the electronic part, the grip-portion core being covered with the spacer, the electronic part being disposed externally to the spacer, and the intermediate body being set such that the opening is positioned to face the overflow portion; and
forming the resin layer by filling the cavity with a fluid resin raw material through the gate and by causing the fluid resin raw material to partly overflow from the overflow portion, the resin layer integrally covering at least the grip-portion core, the electronic part, and the spacer.
